(19) United States
(12) Patent Application Publication
(10) Pub. No.: US 2004/0192574 A1
(43) Pub. Date: Sep. 30, 2004

(54) Use of spherical and monodisperse polymer particles in cleaning agents, and such cleaning agents

(76) Inventors: Bard Saethre, Porsgrunn (NO); Steinar Pedersen, Skien (NO); Anita Martinsen, Skien (NO); Kari-Anne Leth-Olsen, Skien (NO)

Correspondence Address: WENDEROTH, LIND & PONACK, L.L.P., 2033 K STREET N. W., SUITE 800, WASHINGTON, DC, 20006-1021, US

(21) Appl. No.: 10/488,205

(22) PCT Filed: Aug. 23, 2002
(86) PCT No.: PCT/NO02/00296

(30) Foreign Application Priority Data
Aug. 31, 2001 (NO) 20014227

(51) Int. Cl. C08F 14/06; C11D 3/37

(52) U.S. Cl. 510/475; 526/344

(57) ABSTRACT

The present invention concerns the use of polymer particles in cleaning agents, and such cleaning agents. The polymer particles used according to the present invention are spherical and monodisperse with a particle size which may be varied within the range 10 to 50 micrometers. When all the particles are identical in size and otherwise have identical properties, all the particles will contribute equally to the abrasive effect, and the problems of phase separation phenomena in the final formulation will be reduced. Particles of this type cause no problems with scratching either. Another new and surprising feature of the present invention is that spherical monodisperse polymer particles which have a surface evenly covered with “spikes” of the same polymer material as that of the spherical particle demonstrated much improved washing results in comparison with particles which only had a normal smooth surface. The invented cleaning agents produce good washing results without scratching.

The present invention concerns the use of spherical and monodisperse polymer particles in cleaning agents, and such cleaning agents.

During the last twenty years, there has been rapid development in the field of cleaning agents for special applications, for example for cleaning bathrooms, kitchens, cars and boats or tools of various kinds for home and leisure use. There are therefore a number of different products in these markets. The use of particulate material as abrasive in a formulation for cleaning agents (cleaning formulations) is known to produce much improved cleaning properties. Such scouring agents are available in many different forms, from dry scouring powders to creams to liquids, sprays, cloths and serviettes. For cleaning sensitive surfaces on substrates such as tiles, enamel, plastic and lacquered objects, consumers want scouring agents which, in addition to cleaning effectively, do not leave marks and scratches on the surfaces.

Scouring agents are relatively complicated, complex products. Although there are patents which describe the use of organic material as abrasive, the use of inorganic materials, in particular calcium carbonate, is the industry standard. EP 0 216 416 contains an extensive description of the components which are often found in a liquid scouring agent and the techniques used to produce products with the desired properties. This patent also reports the general use of both inorganic and organic abrasives.

In GB 1251972, polyvinyl chloride particles in the size range 50 to 1150 micrometers are used as the abrasive. U.S. Pat. No. 4,693,840 discloses a liquid cleaning agent for cars in which the abrasive is polymer particles consisting of polyethylene in addition to polymer fibres. In U.S. Pat. No. 4,855,067, poly-alpha-methyl-styrene in particulate form is used as the abrasive. WO97/38078 also contains examples of the use of organic polymer particles as abrasives in cleansing creams for cosmetic use as well.

One known problem when solid particles are used as abrasive in liquid cleaning agents is that the particles sediment, and that the flow conditions and dosing properties in connection with use are not optimal. In addition, the different phases in the formulation may separate during storage. One example of a solution to this problem is given in WO97/11147, in which a polymer thickener is used to achieve a stable, easily dosable product. Abrasives are stated here as being everything from calcium carbonate and quartz to polyethylene particles and urea formaldehyde resins.

Another problem is removal of particles after cleaning has been finished. The patent specifications stated and the patent specifications referred to in them are included here as references to the prior art.

The typical degrees of hardness used for the abrasives are from 7 and below on the Mohs hardness scale. Inorganic materials such as calcium carbonate, quartz, diatomite, dolomite, hydroxylated silica and calcium orthophosphate are examples of commonly used abrasives. Although it is claimed that they can be formulated so that they cause little damage to the washable surfaces, it is, however, known that one main problem associated with the use of these agents is that cracks and minor damage are caused to sensitive or soft surfaces. Examples of organic materials used are urea formaldehyde resins, polyvinyl chloride, polyethylene, polymethyl methacrylate and polystyrene as well as copolymers of these materials. Polymer particles of this type cause little or no damage in connection with cleaning, but it is well known that the cleaning result is poorer than when inorganic particles such as calcium carbonate are used.

In the patents referred to, there are large variations in the particle sizes preferred. In some cases, the particles desired are from 1 to 250 micrometers and, in other cases, larger particles, for example in the range 44 to 420 micrometers, are preferred. The disadvantage of these particles as abrasives is that they are either small (<5 micrometers) or that they have a wide particle size distribution. A particle diameter of 30 micrometers is an ideal size to produce an optimal contact area when the particles are moved evenly over a smooth surface. However, it may be an advantage to vary the particle diameter in relation to the surface quality of the substrate. A narrow particle size distribution will mean that all the particles will give an equal cleaning effect and all the particles will have the same sedimentation in the product during storage. To achieve improved abrasive properties, in some cases attempts have been made to crush or grind polymer particles so that their normally round structure is broken and rough, sharp particles are created. One big disadvantage of this, however, is the additional process stages such mechanical techniques entail in relation to using a polymerised particle directly. Another disadvantage is that the particle size distribution usually becomes wider in connection with crushing and grinding.

In the present invention, it was surprisingly found that when polymer particles with a monodisperse particle size distribution, which can be varied in the range 10-50 micrometers, and most preferred with a given surface roughness, were used as the abrasive in a cleaning agent, the cleaning result was equally good or better than when using calcium carbonate, and no scratches or damage were found on cleaned surfaces. The use of these particles therefore meets consumer requirements for effective cleaning without producing negative effects such as scratches and damage on the objects. Such scouring agents will also be easier to formulate when it is necessary to avoid phase separation in the product during storage. These and other objectives of the present invention are achieved with a product and an application which are described and characterised in the claims. The present invention is described in further detail below.

The production of polymer particles is in general known. Different techniques are used to produce different particle sizes and particle size distributions. Small particles around and smaller than 1 micrometer are produced by emulsion polymerisation. The particles are usually created by precipitation of small polymer particles from the aqueous phase. They are stabilised by ionic groups from the initiator or from emulsifier molecules which are adsorbed onto the surface of precipitated particles. Spray drying is often used to transform this latex into a dry powder. In suspension polymerisation, the monomer is agitated to form droplets by means of strong shear forces, and polymerisation takes place as a bulk reaction in the monomer droplets. This technique usually produces particles larger than 100 micrometers, and the size distribution is much wider than that achieved using emulsion polymerisation. When particles in the size range 1 to 100 micrometers are to be produced, more special techniques such as minisuspension or seed polymerisation are used. In minisuspension polymerisation, the monomer droplets are emulsified to form stable, small droplets which retain their size and distribution throughout the polymerisation. In seed polymerisation, already polymerised particles are swollen with new monomer. The size of the end particles is determined by the volume ratio between the initial particles and the new monomer. Very narrow size distributions can be achieved with this technique if the initial particles have a very narrow distribution. When all the particles have the same size, they are called monodisperse particles. A typical measure of whether the particle population can be said to be monodisperse is if GSD<1.35, where GSD is defined as D90/D50, where D90 indicates the particle size where 90 volume % of the particles are smaller than the given diameter and D50 indicates the diameter where 50 volume % of the particles are smaller than the given diameter.

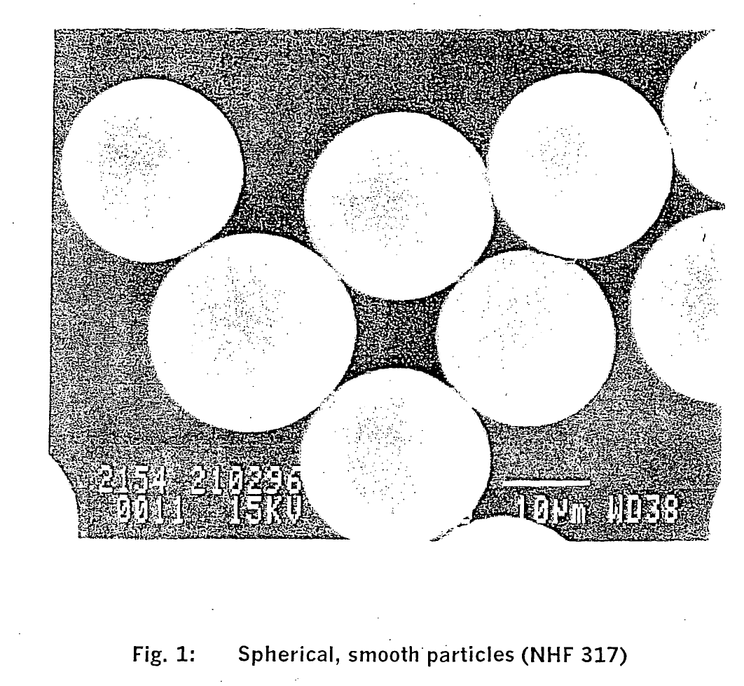

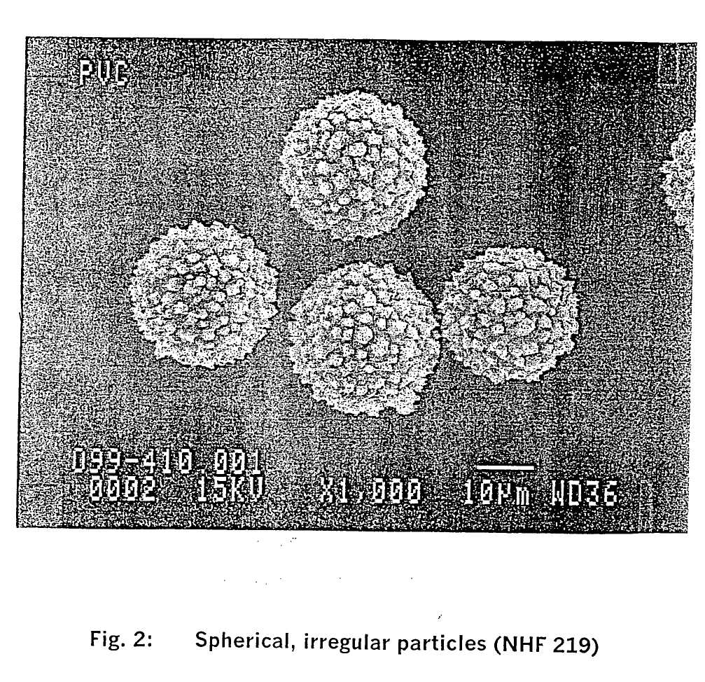

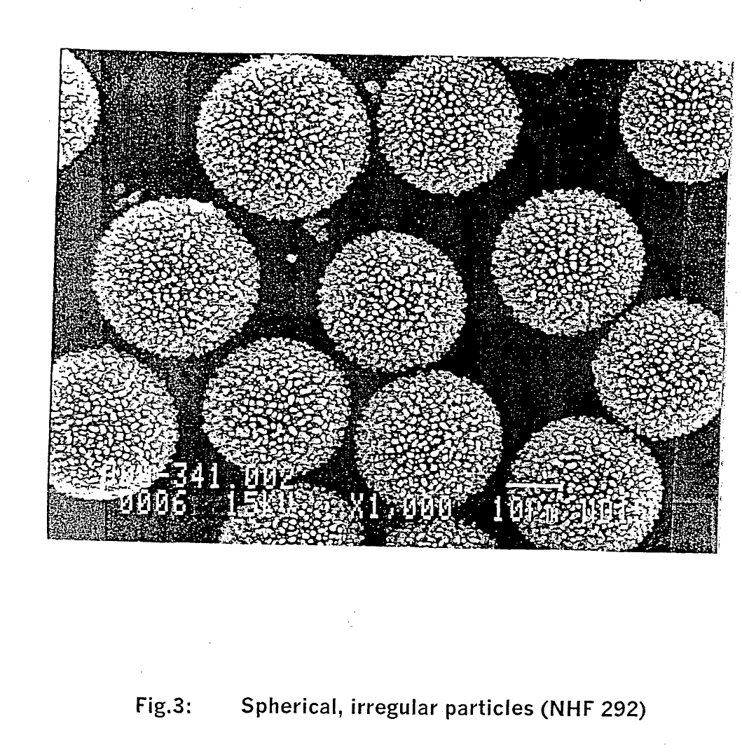

Polymer particles according to the present invention are spherical and monodisperse with a particle size within the range 10 to 50 micrometers. Particles with a size close to 30 micrometers are preferred in particular as this is an almost ideal size for producing the optimal effect. When all the particles are identical in size and have otherwise identical properties, all the particles will contribute equally to the abrasive effect. This is a completely new feature, compared with characteristic features of the polymer particles stated in the patent specifications referred to above. Another completely new and surprising feature of the present invention is that spherical monodisperse polymer particles which have a surface evenly covered with “spikes” of the same polymer material as that of the spherical particle demonstrated much improved abrasive properties in comparison to particles which only had a normal smooth surface. In this way, the properties of irregular, rough particles, which are otherwise only produced following mechanical post-treatment such as grinding and crushing, are produced directly in a polymerised particle. Such a particle type has not previously been described in connection with applications such as abrasives in cleaning agents. For spherical compact particles with a smooth surface, the theoretically calculated surface area will be approximately equal to the surface area measured by means of nitrogen adsorption and the use of the BET isotherm. Preferred particles according to the present invention will, however, deviate quite considerably from this because the spherical particle has protruding irregularities (“spikes”) on the surface which produce additional surface area. These particles will thus have a measured surface area which is more than 1.1 times the area calculated for a spherical, smooth particle. The most preferred particles are those which have a measured area of more than twice the calculated area. FIG. 1 shows spherical, smooth particles and FIGS. 2 and 3 show examples of spherical, irregular particles. The particles particularly preferred are spherical particles with a diameter of 30 micrometers where the protruding irregularities have a mean size of approximately 1 micrometer.

When all the particles are identical in size and otherwise have identical properties, i.e. they are monodisperse, there will be better control of settling and separation between different phases in the formulation during storage. In addition, a monodisperse particle size distribution produces easier redispersion to a homogeneous product if phase separation should have occurred. This is a big advantage in the creation of a homogeneous product, which, in turn, results in improved dosing and flow properties.

The production of monodisperse polymer particles is already known in principle. Of the techniques mentioned above, both emulsion polymerisation and seed polymerisation can produce monodisperse particles. In order to produce particles in the size range 10 to 50 micrometers, seed polymerisation will be best suited. Some of the best known processes in this category are described in patents NO 142082, NO 143403, NO 149108 and U.S. Pat. No. 5,147,937. However, none of these discusses the potential for use in cleaning agents or to produce particles with protruding irregularities on the surface of spherical particles.

Very special conditions are required during polymerisation to produce directly polymerised particles of the type with irregularities on the surface. It was surprisingly found that some polymerisations of the seed type, in which vinyl chloride constituted the majority of the polymer composition, resulted in this type of particles. This process is described in NO 961625, and this patent is included here as a reference to a preferred process for the production of the particles described. Another important factor which can be controlled in this process is the quantity ratio between polyvinyl chloride and the other polymer used as seed. The seed preferred in particular is polymethyl methacrylate, but several other polymer types may also be used. It is also possible to use comonomers in addition to vinyl chloride during seed polymerisation in order to customise the composition of the polymer. This makes it possible to vary the density and hardness of the particles.

The preferred particles have been shown to be particularly well suited as abrasives in cleaning agents for surfaces of glass, enamel, porcelain, ceramics, marble, tiles, metal, wood, concrete, linoleum, paint, lacquer and plastic. In principle, there is no restriction on which formulations and applications can make use of the unique particles.

The present invention will be illustrated in further detail in the examples given below. The examples show the effect of preferred particles according to the present invention used in a scouring cream. Such a formulation consists typically of 1 to 50 weight % polymer particles of the preferred type, between 5 and 50 weight % soap and between 20 and 90 weight % water. The soap may be chosen from among a wide range of surfactants, which are well known in the art. In addition, a complete formulation will generally include preservatives, colour and perfume or other odour additives. The particles according to the present invention may also be used as abrasives in dry scouring powders, liquid scouring agents, sprays, serviettes and cloths.

### EXAMPLE 1

### Polymer Particles

Table 1 shows examples of different types of abrasives. All the polymer particles are supplied by Norsk Hydro ASA. All the samples consist mainly of polyvinyl chloride so that the physical properties such as density and hardness will be almost identical.

TABLE 1
Characteristics of abrasives used

| | | Mean | Particle | | | Ratio between |
|---|---|---|---|---|---|---|
| | | diameter | size distribution | Surface | Theoretical | measured and |
| | | (Coulter | (Coulter | area | surface | theoretical |
| | Surface | LS-230) | LS-230) | (BET) | area | surface |
| Sample | morphology | (μm) | (GSD) | (m²/g) | (m²/g) | area |
| S6775 | irregular | 160 | 1.38 | | | |
| | | | polydisperse | | | |
| NHF317 | spherical with | 25 | 1.14 | 0.15 | 0.1714 | 0.88 |
| | smooth | | monodisperse | | | |
| | surface | | | | | |
| NHF219 | spherical with | 29 | 1.15 | 0.30 | 0.1478 | 2.03 |
| | irregular, | | monodisperse | | | |
| | spiked | | | | | |
| | surface | | | | | |
| NHF292 | spherical with | 29 | 1.18 | 0.60 | 0.1478 | 4.06 |
| | irregular, | | monodisperse | | | |
| | spiked | | | | | |
| | surface | | | | | |
| NHF245 | spherical with | 14 | 1.14 | 0.30 | 0.306 | 0.98 |
| | smooth | | monodisperse | | | |
| | surface | | | | | |
| P14 | spherical with | 18 | 2.13 | | | |
| | agglomerates | | polydisperse | | | |
| DP1510 | spherical | 4 | 3.31 | | | |
| | | | polydisperse | | | |
| Calcium | randomly | 30 | >2 | | | |
| carbonate¹ | rough | | polydisperse | | | |

¹Calcium carbonate was chosen as an example of a commonly used inorganic abrasive.

It only makes sense to state the ratio between the measured and theoretical surface area when the particles are monodisperse because the area can then be calculated as for a perfect sphere. With polydisperse distributions, it is virtually impossible to calculate the area correctly.

### EXAMPLE 2

### The use of the Particles in Formulations

Formulations of the various particle types as shown in Table 2 were produced.

TABLE 2
Formulations which contain polymer particles

| | Formulation | | | | | | | |
|---|---|---|---|---|---|---|---|---|
| | 1 | 2 | 3 | 4 | 5 | 6 | 7 | 8 |
| S6775 | 20 | — | — | — | — | — | — | — |
| NHF317 | — | 20 | — | — | — | — | — | — |
| NHF219 | — | — | 20 | — | — | — | — | — |
| NHF292 | — | — | — | 20 | — | — | — | — |
| NHF245 | — | — | — | — | 20 | — | — | — |
| P14 | — | — | — | — | — | 20 | — | — |
| DP1510 | — | — | — | — | — | — | 20 | — |
| Calcium | — | — | — | — | — | — | — | 20 |
| carbonate | | | | | | | | |
| Liquid phase | 80 | 80 | 80 | 80 | 80 | 80 | 80 | 80 |
| PH | 11.5 | 11.5 | 11.5 | 11.5 | 11.5 | 11.5 | 11.5 | 11.5 |
| Viscosity | 500 | 500 | 500 | 500 | 500 | 500 | 500 | 500 |
| (mPas) | | | | | | | | |

In addition to water, the liquid phase consists of surfactants. After agitation, all the formulations behaved identically with regard to stability, dosing properties, sedimentation, pH and viscosity. However, there was a clearer tendency to sedimentation of particles in samples 1 and 8.

### EXAMPLE 3

### Washing Tests

The formulations indicated in Table 2 were used for washing tests on model dirt (stearate/palmitate fats), which was applied to glossy Plexiglas panels. The results in Table 3 are from subjective assessment by experts with regard to the cleanness of the panel (scale 0-8, where 8 is a perfect washing result) and the degree of scratching (scale 0-8, where 0 is no scratches at all) caused to the panel by the cleaning. 5 panels were washed with each sample.

TABLE 3
Washing tests (Plexiglas panel)

| | Formulation | | | | | | | |
|---|---|---|---|---|---|---|---|---|
| | 1 | 2 | 3 | 4 | 5 | 6 | 7 | 8 |
| Washing result | 2.8 | 5.8 | 7.1 | 6.6 | 5.2 | 5.2 | 4.9 | 7.0 |
| Scratches | <1 | <1 | <1 | <1 | <1 | <1 | <1 | 7 |

The results clearly show the advantage of using organic material instead of inorganic calcium carbonate in order to avoid scratching of the surface. All the formulations containing polymer particles caused no damage to the panels, while calcium carbonate produced considerable damage, and the surface lost its glossy appearance. The large polymer particles with a polydisperse particle distribution used in formulation 1 are a typical example of particles previously reported used as abrasives. As expected, it can be seen that they produce a poor washing result. Smaller particles produce a better washing result (formulations 6 and 7) compared with the large particles in formulation 1. If we compare formulations 2 and 6, we can see that a monodisperse particle size distribution produces a better cleaning effect than a polydisperse size distribution in this size range. The results in Table 3 also indicate that particles of approximately 30 micrometers produce the best cleaning effect. The monodisperse particles with an irregular surface produce a washing result equivalent to that of calcium carbonate.

In the same way as for the tests in Table 3, the formulations in Table 2 were used for washing tests on model dirt applied to acid-proof steel panels. The results in Table 4 are from subjective assessments in the same way as stated above.

TABLE 4
Washing tests (acid-proof steel)

Formulation

| | 3 | 8 |
|---|---|---|
| Washing result | 7 | 7 |
| Scratches | 0 | 1 |

In this case too, the organic polymer particles according to tie present invention produced no scratches in the surface of the substrate, and the washing result is as good as for calcium carbonate.

1-9. (Cancel)

10. Use of polymer particles, where the particles have a geometric size distribution less than 1.35, are spherical with spikes or irregularities on the surface, have a size which may be varied in the range between 10 and 50 micrometers and where vinyl chloride constitutes the majority of the polymer composition, in cleaning agents.

11. Use in accordance with claim 10, where the particles have spikes or irregularities on the surface which lead to the surface area being at least 1.1 times larger, preferably more than 2 times larger, than the surface area of smooth spherical particles of the same size.

12. Use in accordance with claim 10, where the polymer particles are produced by means of seed polymerization in which vinyl chloride constitutes the majority of the polymer composition.

13. Use in accordance with claim 10, in cleaning agents for surfaces of glass, enamel, porcelain, ceramics, marble, tiles, metal, wood, concrete, linoleum, paint, lacquer and plastic.

14. Cleaning agents, characterized in that they contain polymer particles as stated in claim 10 and possibly used ingredients such as surfactants, solvents, viscosity and acidity regulators, odorants and colorants, preservatives and other abrasives.

15. Cleaning agents as claimed in claim 14, characterized in that the cleaning agents are cloths, serviettes or sponges.

16. Liquid cleaning agents, characterized in that they contain polymer particles as stated in claim 10, where the polymer particles constitute between 0.1 and 60 weight % preferably between 5 and 30 weight % of the cleaning agent.

17. Solid cleaning agents, characterized in that they contain polymer particles as stated in claim 10, where the polymer particles constitute between 50 and 100 weight %, preferably between 60 and 90 weight % of the cleaning agent.

18. Use in accordance with claim 11, where the polymer particles are produced by means of seed polymerization in which vinyl chloride constitutes the majority of the polymer composition.

19. Use in accordance with claim 11, in cleaning agents for surfaces of glass, enamel, porcelain, ceramics, marble, tiles, metal, wood, concrete, linoleum, paint, lacquer and plastic.

20. Use in accordance with claim 12, in cleaning agents for surfaces of glass, enamel, porcelain, ceramics, marble, tiles, metal, wood, concrete, linoleum, paint, lacquer and plastic.

21. Cleaning agents, characterized in that they contain polymer particles as stated in claim 11 and possibly used ingredients such as surfactants, solvents, viscosity and acidity regulators, odorants and colorants, preservatives and other abrasives.

22. Cleaning agents, characterized in that they contain polymer particles as stated in claim 12 and possibly used ingredients such as surfactants, solvents, viscosity and acidity regulators, odorants and colorants, preservatives and other abrasives.

23. Liquid cleaning agents, characterized in that they contain polymer particles as stated in claim 11, where the polymer particles constitute between 0.1 and 60 weight %, preferably between 5 and 30 weight % of the cleaning agent.

24. Liquid cleaning agents, characterized in that they contain polymer particles as stated in claim 12, where the polymer particles constitute between 0.1 and 60 weight %, preferably between 5 and 30 weight % of the cleaning agent.

25. Solid cleaning agents, characterized in that they contain polymer particles as stated in claim 11, where the polymer particles constitute between 50 and 100 weight %, preferably between 60 and 90 weight % of the cleaning agent.

26. Solid cleaning agents, characterized in that they contain polymer particles as stated in claim 12, where the polymer particles constitute between 50 and 100 weight %, preferably between 60 and 90 weight % of the cleaning agent.
